(19) United States
(12) Patent Application Publication
(10) Pub. No.: US 2026/0309137 A1
(43) Pub. Date: Oct. 8, 2026

(54) HIGH PRESSURE GAS COMPRESOR ENVIRONMENTAL RECOVERY SYSTEM

(71) Applicant: Flowco MasterCo LLC, Houston, TX (US)

(72) Inventors: Will A. Nelle, San Angelo, TX (US); Chris Lindsey, Carthage, TX (US)

(21) Appl. No.: 19/098,707

(22) Filed: Apr. 2, 2025

(51) Int. Cl. F04B 17/05; F04B 23/06; F04B 53/06; F02B 43/10; F02M 35/10

(52) U.S. Cl. CPC F04B 17/05; F04B 23/06; F04B 53/06; F02B 43/10; F02B 2043/103; F02M 35/10222

(57) ABSTRACT

The present disclosure is directed to an environmental recovery system and method for use with a natural gas compressor. The environmental recovery system includes an oil and gas recovery system that reroutes waste oil and gas blow-by from rod packings into the crankcase such that oil passing through the rod packing may be reused. An evacuator system removed gases introduced into the crankcase by the recovery system and redirects these gases into an intake of an engine connected to the compressor where the gases are burned as fuel. The environmental recovery system recovers waste streams of a natural gas compressor, which are normally liabilities for a compressor operator, and converts these waste streams to useful assets.

### BRIEF DESCRIPTION OF THE DRAWINGS

The accompanying drawings form a part of this disclosure and are incorporated into the specification. The drawings illustrate example embodiments of the disclosure and, in conjunction with the description and claims, serve to explain various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein

FIG. 1A is a perspective view of a natural gas compressor, in an embodiment.

FIG. 1B is a top view of a natural gas compressor, in an embodiment.

FIG. 2 shows a schematic diagram of a compressor skid unit in an embodiment.

FIG. 3 shows a perspective view of a compressor skid unit in in an embodiment.

FIG. 4 shows a view of a distance piece used with a compressor, in an embodiment.

FIG. 5 shows a view of a distance piece used with a compressor in an embodiment.

FIG. 6 shows a schematic diagram of a gas compressor package with an emissions evacuator system in an embodiment.

FIG. 7 shows a side view of a compressor skid unit with an emissions evacuator system in an embodiment.

FIG. 8 shows an exemplary graph of a monitored compressor crankcase pressure over time, in an embodiment.

### DETAILED DESCRIPTION

The systems, methods, and devices of the present disclosure each have several aspects, no single one of which is solely responsible for its desirable attributes. Without limiting the scope of this disclosure as expressed by the claims that follow, some features will now be discussed briefly. After considering this discussion, and particularly after reading this section, one will understand how the features of this disclosure provide advantages that include reduced emissions such as waste oil and greenhouse gases (GHG) from natural gas compressor packages.

Wellbores drilled for the production of oil and gas often produce fluids in both the gas and liquid phases. Produced liquid phase fluids may include hydrocarbon oils, natural gas condensate, and water. When a well is first completed, the initial formation pressure is typically sufficient to force liquids up the wellbore and to the surface along with the produced gas. However, during the life of a well, the natural formation pressure tends to decrease as fluids are removed from the formation. As this downhole pressure decreases over time, the velocity of gases moving upward through the wellbore also decreases, thereby resulting in a steep production decline of liquid phase fluids from the well. Additionally, the hydrostatic head of fluids in the wellbore may significantly impede the flow of gas phase fluids into the wellbore from the formation, further reducing production. The result is that a well may lose its ability to naturally produce fluids in commercially viable quantities over the course of the life of the well.

Various artificial lift methods have been developed to increase production from such a well. One such artificial lift method is gas lift. In gas lift methods, a gas is injected into the wellbore downhole to lighten, or reduce the density of, the fluid column by introducing gas bubbles into the column. A lighter fluid column results in a lower bottom-hole pressure, which increases fluid production rates from the well. Gas lift is a method that is very tolerant of particulate-laden fluids and is also effective on higher gas oil ratio (GOR) wells. As such, gas lift has become a commonly utilized artificial lift method in shale oil and gas wells.

Gas lift was initially introduced in the mid-19^{th} century. With the advent of the horizontal oil shale boom in recent years, gas lift methods have enjoyed a resurgence in popularity. This is due, in part, to the ability of gas lift methods to handle solids such as frac sand, and because deviated wellbores do not impose challenges as they do with beam lift or electric submersible lift. In addition, producing bottom-hole pressures achieved with gas lift can often be below those obtained with these other forms of lift, which may be a benefit to oil and gas operators. These other forms of lift are also susceptible to problems created by gas interference. This gas interference, caused by lighter hydrocarbons vaporizing when exposed to lower pressures, only serves to increase the efficacy of gas lift.

In conventional gas lift methods, a gas lift compressor at the surface injects gas through multiple gas lift valves positioned vertically along the production tubing string. Conventional gas lift compressors typically have a discharge pressure in the range of 1,000 psig to 1,200 psig. However, there are disadvantages in conventional gas lift compressor systems. For instance, the fluid lift rates achievable by conventional gas lift compressors are typically limited, which limits the effectiveness of gas lift operations. Although conventional gas lift compressors may achieve higher lift rates than some other artificial lift methods, such as beam pumping, or the sucker-rod lift method, gas lift typically does not produce the same lift rates of other methods such as electric submersible pumps (ESPs).

To overcome limited fluid lift rates, the use of HPGL compressors has gained traction in the oil and gas industry in recent years. The HPGL process is a variation on conventional gas lift methods in which no gas lift valves are required in the production tubing string. Instead, compressed gas is injected into the wellbore fluid column near the end of tubing (EOT), thereby reducing the density of the entire fluid column, which provides higher production rates as compared to conventional gas lift methods. Like conventional gas lift compressors, HPGL compressors are tolerant of particulate-laden fluids and high GORs and typically provide fluid lift rates comparable to ESPs. However, the HPGL gas lift process requires a source of compressed gas at a significantly higher pressure than the compressed gas utilized in conventional gas lift processes. HPGL gas lift compressors are typically designed to produce compressed gas at a discharge pressure of up to 4,000 psig in order to provide an adequate injection gas flow rate. Many such HPGL gas compressors are incorporated into natural gas compressor packages located to serve one or more well sites. Tens of thousands of compressors are in existence in the United States alone. In addition, similar compressors are used in conjunction with pipelines to move natural gas over short or long distances.

Many compressor packages operate continuously (24/7/365). Natural gas compressor packages are typically powered by a natural gas fired internal combustion reciprocating engine, which commonly drives a reciprocating compressor. Auxiliary to these components, the compressor package typically also various other components (e.g., scrubbers, actuators, control valves, etc.). Due to the availability of high-pressure gas (e.g., compressed natural gas) many of the components of natural gas compressor packages are pneumatically operated using compressed natural gas.

Each of the components on a compressor package have inherent leaks of gaseous methane and non-methane hydrocarbon emissions. For instance, blow-by between cylinders and crankcases is present in the natural gas engine and compressor. This is especially true for HPGL compressors due to the high pressures involved. In addition, scrubbers and other pneumatic devices typically vent compressed gas during or after operation. Industry practice has been to simply allow these emissions to vent into the atmosphere. Though this practice has historically been extremely commonplace, concerns over global warming from greenhouse gases has created the desire and need to reduce greenhouse gas emissions. These greenhouse gas emissions from engine and compressor crankcases, as well as other compressor package pneumatic devices are no exception. In addition, high pressure gas compressors also utilize a significant amount of oil to lubricate compression cylinders and rod packings. As this oil becomes contaminated with natural gas blow-by, the oil is discarded forming another potential source of emissions and/or another waste hydrocarbon stream.

In an embodiment, a compressor environmental recovery system and method is provided that converts two waste streams of a natural gas compressor into useful assets for a compressor operation. In operation, an oil and gas recovery system drains fluids passing through the rod packings of a natural gas compressor into the crankcase of the natural gas compressor. The recovery system thus recovers oil passing through the rod packing which may them be reused by a lubrication and/or force reed lubrication system of the compressor. Gases introduced into the crankcase by the oil and gas recovery system are subsequently removed from the crankcase by an evacuator system that applies a suction or vacuum to the interior of the crankcase and directs these gases into an air intake of an internal combustion engine powering the compressor.

In an embodiment, a natural gas compressor package is provided that includes a natural gas compressor and an internal combustion engine that powers the natural gas compressor. The natural gas compressor includes a plurality of drain conduits that direct oil and gases passing through rod packings of the compressed into the crankcase of the compressor. The natural gas engine includes a vacuum conduit extending between an interior of the crankcase of the compressor and an air inlet of the internal combustion engine. Oils introduced into the crankcase are reused while gases introduced into the crankcase are evacuated and burned as fuel in the internal combustion engine.

In an embodiment, a natural gas compressor includes a pressure sensor or transducer operative to monitor an internal pressure of a crankcase of the natural gas compressor. A controller operatively coupled to the pressure sensor monitors the internal pressure of the crankcase over time. Upon the internal pressure exceeding a predetermined baseline, the control generates an output indicating that one or more of components is leaking excessing gases.

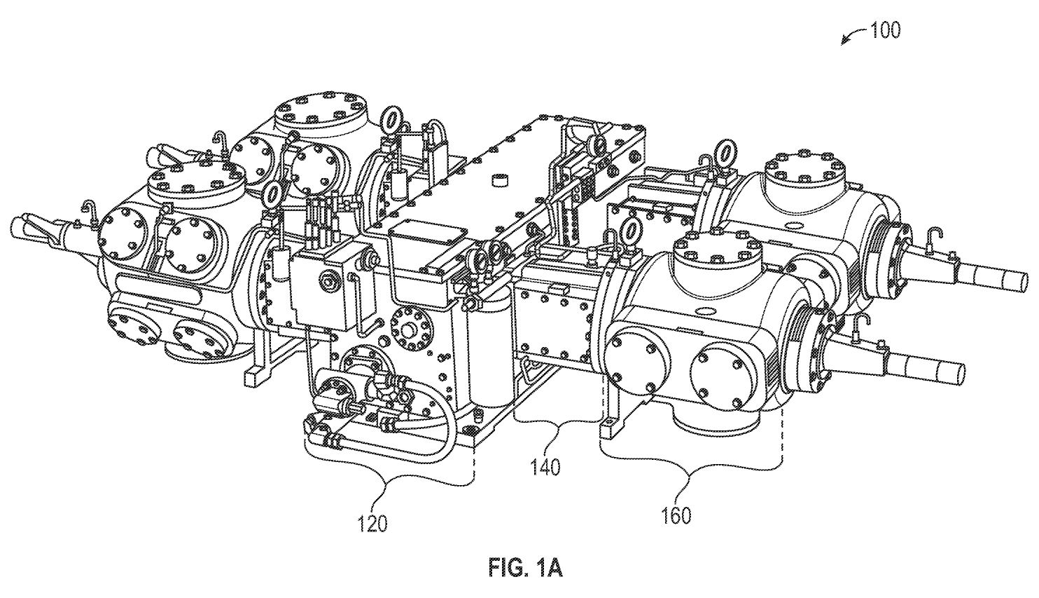

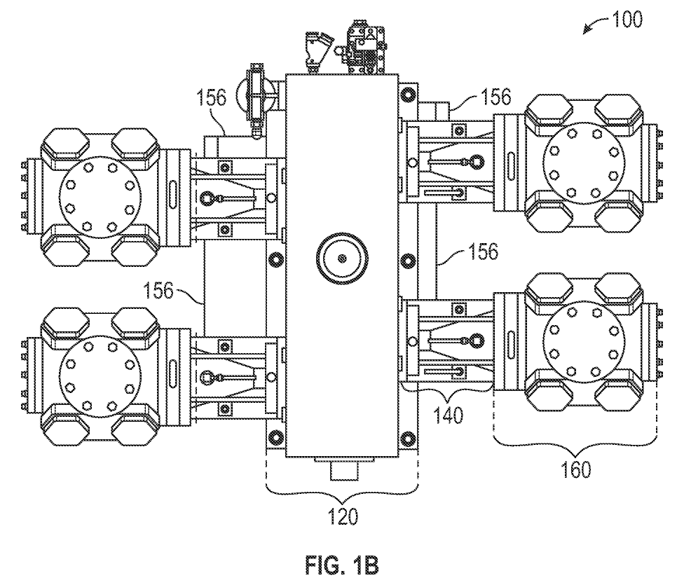

FIGS. 1A and 1B illustrate a four-throw compressor 100 that may be paired with an internal combustion engine (e.g., natural gas engine) according to an embodiment. The compressor 100 is a combination of frame (e.g., crankcase) 120, cylinder assemblies 160 and distance pieces 140. The main internal components of a compressor frame 120 include the base casting/housing, crankshaft, connecting rods, crossheads, and crosshead guides (not shown), as well known by those skilled in the art. The cylinder assemblies 160 each include an internal compression cylinder and piston as well as gas inlets and outlets. The distance pieces 140 are sections of the gas compressor 100 between the frame/crankcase 120 and the compressor cylinders 160 which isolates the two areas from one another. Each distance piece 140 houses a portion of the piston rod that extends between the piston in the cylinder assembly and the crossheads of the crankcase 120. The distance piece includes at least one packing seal that seals the reciprocating piston rod to prevent oil from being transferred along the piston rod into the cylinder area of the compressor and/or to minimize gasses passing from the cylinder area into the crankcase. In operation, an engine (not shown) rotates the compressor, which uses the pistons to compress gas in the compressor cylinders as the engine drives the pistons back-and-forth inside the cylinders. Each cylinder may be double acting, meaning that it compresses gas when the piston rod travels in as well as when it travels out. Alternatively, the cylinders may be single acting. Though a four-throw compressor is illustrated, it will be appreciated that the four-throw compressor is provided by way of illustration and that the systems and methods discussed herein may be utilized with other compressor configurations (e.g., two-throw; six-throw etc.).

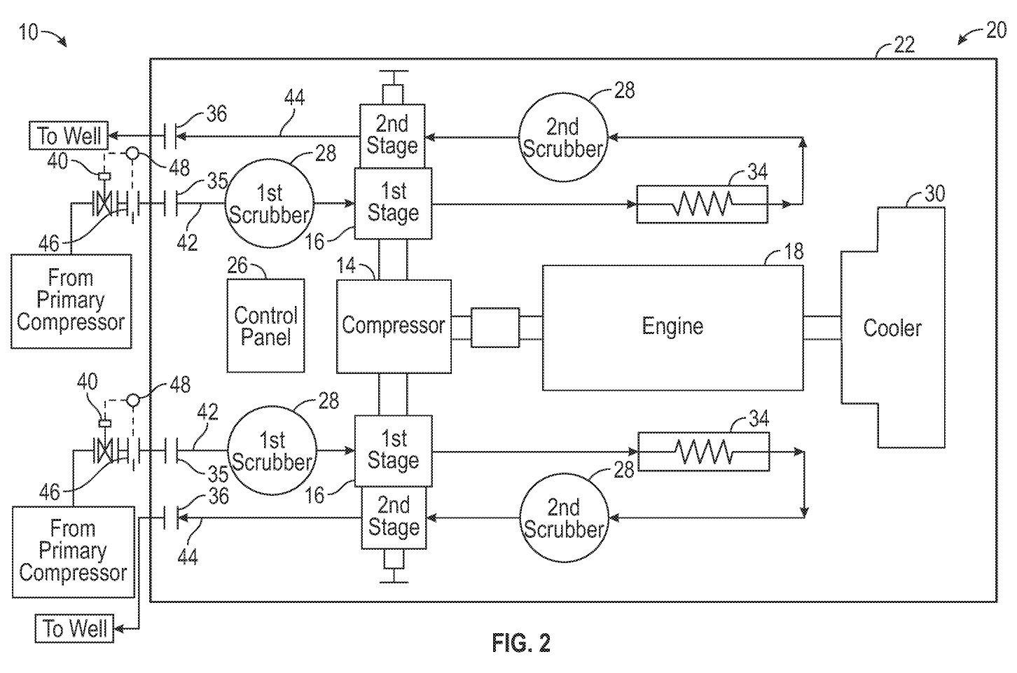

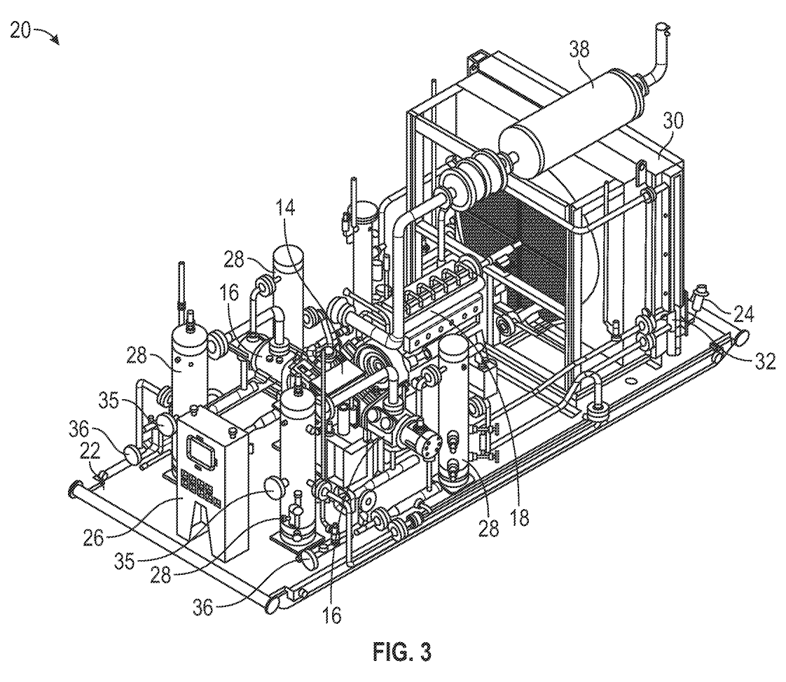

FIGS. 2-3 illustrate a natural gas compressor package, in an embodiment. In this illustrated embodiment, the natural gas compressor package is a self-contained or skid mounted system allowing the system to be portable. In such an embodiment, the systems and methods disclosed herein may be an entirely on-skid system requiring no off-skid infrastructure. Though discussed in relation to an on-skid embodiment utilized primarily for high pressure gas injection into wells, it will be expressly understood that aspects of the present disclosure may be utilized with off-skid systems as well as other compressor systems (e.g., pipeline compressor systems). FIG. 2 shows a schematic diagram of a compressor skid, in an embodiment. FIG. 2 illustrates the exemplary compressor skid in greater detail. In each of these figures, the compressor system includes an illustrative reciprocating compressor, which may be used to provide gas lift to two wells. However, this is not a requirement.

As shown in FIG. 2, the natural gas compressor package or “compressor system” 10 includes a compressor 100 having a plurality of compressor cylinder assemblies 160. A compressor engine 18 is operably coupled to the compressor 14 and configured to simultaneously drive each of the compressor cylinder assemblies 160. Thus, the system may utilize a single engine 18 (e.g., natural gas engine) to operate all of the compressor cylinder assemblies 160. As used herein, a “compressor cylinder assembly” refers to a cylinder having a piston disposed therein to compress and displace gas within the cylinder, wherein the piston is driven by a rotating crankshaft coupled to the compressor engine 18. Each compressor cylinder assembly 160 has a gas inlet line 42 and its own dedicated gas outlet line 44, which may supply compressed gas to, for example, a well. In an exemplary embodiment, a single compressor skid 20 may provide wellbore injection gas one or more individual wells.

To independently control the gas flow rate to each well, the compressor system 10 may further comprise one or more control valves 40 each corresponding to a respective compressor cylinder assembly 160. Each control valve 40 may be positioned on a gas inlet line 42 upstream of a compressor cylinder assembly 16. Each control valve 40 is configured to independently control the suction pressure to each respective compressor cylinder assembly 160 and thereby to independently control a gas flow rate through the gas outlet line 44 of each compressor cylinder assembly 160. These valves 40 are, in an embodiment, pneumatically controlled by a controller 48, which opens and closes the valves using compressed natural gas. Thus, the valves/controller are pneumatic devices. To control the gas flow rate through each of the gas outlet lines 44, the system 10 may include flow meters 46 and/or the controllers 48 each corresponding to one of the control valves 40.

In an embodiment, each compressor cylinder assembly 160 may include a first compression stage and a second compression stage. The gas in the inlet gas line 42 is compressed in the first stage and then passes through a cooler 34 before being further compressed to its final discharge pressure in the second stage. The compressor skid 20 shown in FIG. 3 may utilize separate coolers for each gas stream and a cooler 30 for the compressor engine 18. In an alternative embodiment, as shown in FIG. 2, a common cooler structure 30 may be utilized to cool compressed gas streams from all of the separate cylinder assemblies 160, as well as to provide cooling water to the compressor engine 18. The cooling structure 30 may include separate cooling sections 32 designated for the compressed gas process streams. The skid 20 may also include a compressor exhaust 38 for the engine 18. The cooler 30 may define a radiator. A pneumatic actuator 24 may control airflow through the cooler (e.g., by controlling louvers of an air flow path of the cooler; not shown).

In an embodiment, the compressor skid 20 comprises a plurality of scrubbers 28 each corresponding to a respective compressor cylinder assembly 16. The scrubbers 28 are configured to remove liquid droplets, which may include a variety of liquid hydrocarbons that may condense out of the gas stream. In an embodiment, as shown in FIG. 2, each compressor cylinder assembly 16 has two scrubbers 28, one upstream of the first stage compressor and one upstream of the second stage compressor and downstream of the cooler 34. In other embodiments three scrubbers may be utilized.

As shown in FIG. 3, components of the compressor system 10 share a common skid unit frame 22 to which the components may be mounted to provide a portable skid-mounted compressor unit 20 that can be transported to any field location. As used herein, a “skid” refers to a compressor system having components mounted onto a frame 22 so that the system may be transported as a single unit 20. In addition, the skid is sized to that the unit may be transported by cargo truck or rail as a single unit to any location as needed. The compressor 14 and the compressor engine 18 are mounted directly onto the skid unit frame 22. In addition, a control panel 26, scrubbers 28, and coolers 34, which may be incorporated into a single cooling structure 30, along with associated piping, may also be mounted directly onto the skid unit frame 22.

The portable compressor skid 20 may have a gas inlet line flange 35 and a gas outlet line flange 36 for connecting the gas inlet lines 42 and the gas outlet lines 44, respectively, to the compressor skid 20 after the skid has been transported to its location for intended use. In this embodiment, the process control equipment is thus “off-skid” and is installed after the skid 20 is put into place. In an optional embodiment, the skid 20 may include the control valves 40, flow meters 46, and controllers 48 “on-skid” for easier installation. In this embodiment, the control valves 40, flow meters 46, and controllers 48, and associated piping may additionally be mounted onto to the skid unit 20 so that later installation of these components is not required.

As noted above, various components on a compressor package leak gaseous methane and/or non-methane hydrocarbons (e.g., collectively emissions). In relation to reciprocating compressors, similar to those discussed above, areas of frequent leaks include valves, flanges and other fittings on the compressor. However, the highest volume of natural gas leakage is linked with the piston rod packing systems. Specifically, some high pressure gas from the compression cylinders leaks through the rod packings. This leakage is sometimes referred to as “blow-by”. According to some estimates, over 51,000 reciprocating compressors operate within the natural gas industry in the United States. On average, each of these compressors functions with 4 cylinders. This represents more than 200,000 piston rod packing systems in service. These systems contribute methane emissions – more than 2.4 Bcf per annum by some estimates – to the atmosphere. This makes it one of the largest sources of methane emissions at natural gas compressor installations. Under normal circumstances, every packing system leaks. However, the amount of leakage depends significantly on the fitting as well as alignment of the packing components, cylinder pressure, and amount of wear and tear on the rod shaft and rod packing rings. On average, a properly aligned and fitted brand-new packing system is estimated to lose from about 11 to 12 scfh (standard cubic feet per hour). But as the system ages, the leak rate will increase accordingly, usually from wear on the piston rod and the rod packing rings.

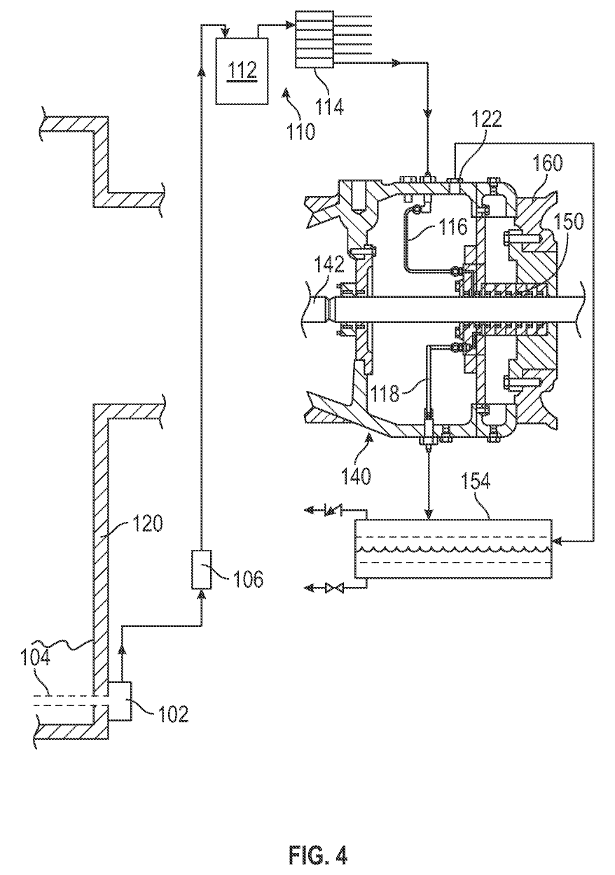

FIG. 4 illustrates one embodiment of a distance piece 140 that, when in use, is disposed between and fixedly connected the compressor frame/crankcase 120 and the cylinder assembly 160 (partially shown). As shown, a reciprocating piston rod 142 extends through the interior of the distance piece 140. Though not shown, the piston rod 142 has a first end attached to a piston disposed within a cylinder in the cylinder assembly and a second end attached to a crankshaft (e.g. via a crosshead; not shown) in the compressor frame/crankcase 120. Disposed within the distance piece 140 and extending into a flange of the cylinder assembly 160 is a compressor rod packing 150 (hereafter rod packing), which remains stationary as the piston rod 142 reciprocates. The rod packing 150 is typically made up of a series of flexible annular “packing rings” that fit around the shaft of the piston rod 142 to form a seal with the piston rod 142. Typically, packing cups secure the packing rings and a surrounding spring holds the rings tightly against the rod surface. Variations exist in such rod packings.

The rings of the rod packing 150 are lubricated with high-pressure oil, which improves the overall seal of the rod packing 150. More specifically, high-pressure oil is supplied via a force feed system that draws engine oil from an outlet 102 from a gallery 104 of the natural gas compressor. In most natural gas compressors, two systems lubricate the compressor: The frame oil system and the force feed system. The frame oil system (not shown) is a pressurized oil system that draws oil from the crankcase sum and supplies oil to the crankshaft, connecting rods and crossheads via various passageways (i.e., oil galleries). In the illustrated embodiment, the frame oil system also supplies low pressure oil to the force feed system 110. The oil passes through the oil outlet 102 and may pass through an optional inline filter 106 to a force feed lubricator pump 112. The force feed lubricator pump increases the pressure of the oil and provides oil to a distribution block or manifold 114, which supplies oil to each of the rod packings 150 as well as to the cylinders of the cylinder assemblies (not shown). The pressurized oil passed enters the distance piece 140 and passes through an oil inlet line 116 connecting with interior passages in the rod packing 150. The high-pressure oil circulates between the rings of the rod packing 150. As noted above, even when new, the rod packing 150 suffers some gas leakage between the rod packing rings and the piston rod 142. In addition to gas leakage, some of the high-pressure oil also leaks past the piston rings. Due to the high pressures of the natural gas compressed by the compressor assembly 160, natural gas may become infused with the oil. To remove the gas and oil leaking past the rings, the rod packing 150 further includes an internal drain passage or vent that may be connected to an outlet line 118. In some HPGL gas lift operations, the leakage of oil past rod packing of each cylinder may be on the order of 1 pint per day. That is, two quarts of oil per compressor per day for a four-cylinder compressor. The outlet line 118 exits the distance piece to drain the leaked oil and gases comingled and/or infused with the leaked oil.

Current industry practice is to collect the leaked oil and gases in an oil separation pot 154. That is, oil exiting the rod packing 150 is collected in a non-pressurized reservoir where gasses infused with the oil readily off-gas under reduced pressure. In addition, natural gas from the interior of the distance piece may be collected from a vent 122 and provided to the oil separation pot 154. The collected gases are then vented to atmosphere or sent to a flare where they are burned. The oil in the separation pot 154 is eventually discarded as waste oil.

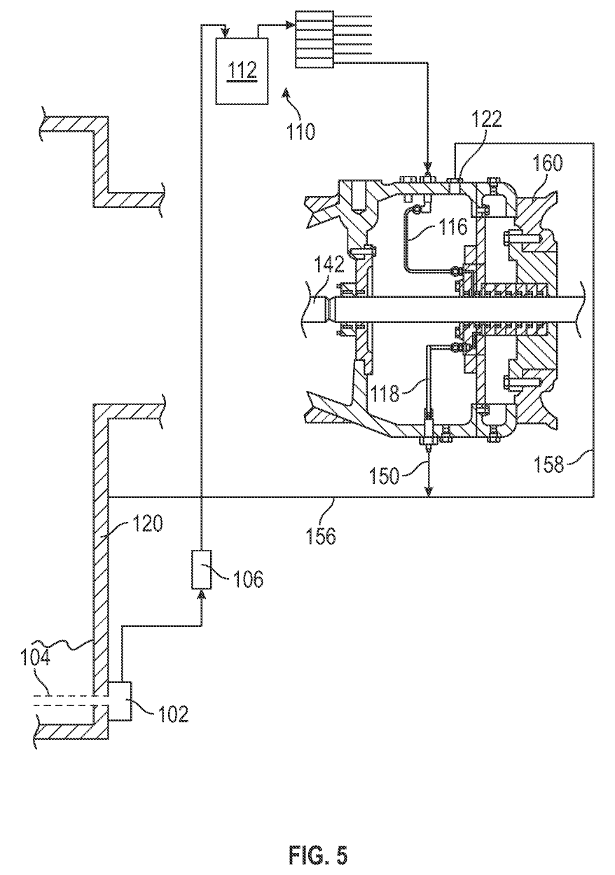

FIG. 5 illustrates a portion of the emission control system of the present disclosure. As shown, the emission control system removes the oil separation pot and instead connects the oil outlet line 118 exiting the distance piece 140 with a conduit 156 (e.g., drain conduit) that fluidly connect to the interior of the fame crankcase 120. In addition, gasses collected from the vent 122 may likewise be connected to the conduit 156, for instance, by a secondary or vent conduit 158. However, the secondary vent conduit 58 may be omitted or may be separately routed to the crankcase. The drain conduit 156 directs the collected oil and gases into the interior of the crankcase 120, where gases infused within the oil may off-gas in the low-pressure environment within the compressor crankcase 120. In a full drainage system, each rod packing of each cylinder of a compressor 100 may each include a separate drain conduit 156 though one or more of these drain conduits may be interconnected with one or more other drain conduits. See, e.g., FIG. 1B. That is, a compressor may include a network or plurality of drain conduits to recover oil from a plurality rod packings. This portion of the emissions control system is termed an oil and gas recovery system and this portion of the system recovers waste oil and blow-by gases. The “recovered oil” may then be reused with the frame oil and force feed systems. That is, it has been recognized that any contaminations within the recovered oil may be effectively filtered by the existing filtration system of the frame oil system. As known by those skilled in the art, the frame oil system draws oil from the crankcase sump and passes the oil through a filter prior to applying the oil to the various galleries to lubricate the frame component or supply the force feed system. In this regard, the approximately one quart of oil previously discarded each day (e.g., in a four-cylinder compressor) are recovered. In addition to elimination a waste stream, such recovery provides a significant economic benefit to compressor operators some of whom operate hundreds or thousands of natural gas compressors.

While effectively recovering the oil from the rod packings, the gases introduced into the compressor crankcase 120 must eventually be vented. While these gases could be vented to atmosphere or to a flare, it has been further recognized that these gases can collected and put to beneficial use. More specifically, gases collected from the interior of the crankcase are routed to an internal combustion gas engine (e.g., natural gas engine) powering the compressor and these gases are burned as fuel gas thereby converting a waste stream into useful work. In addition, volatile emissions are no longer released into the environment but, rather, neutralized and released into the environment as inert gases.

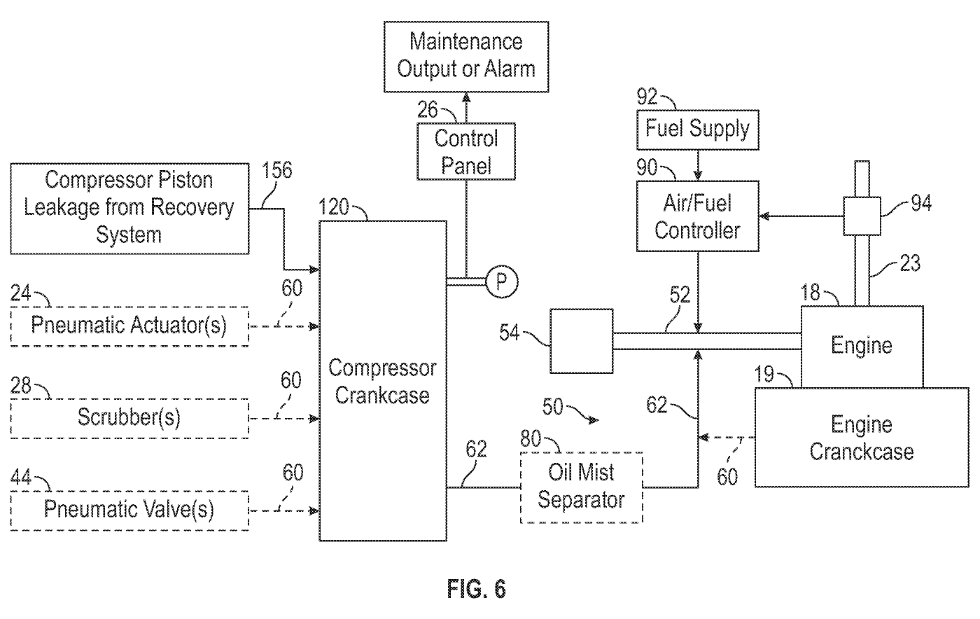

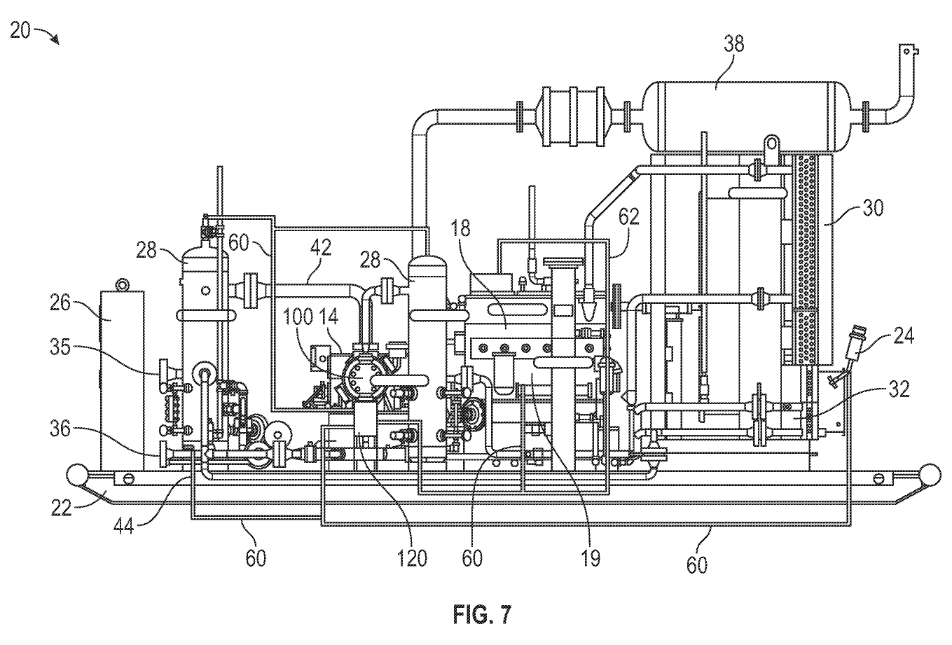

To remove and utilize natural gas from the interior of the compressor crankcase, the present disclosure also incorporates an evacuator system 50 that draws natural gases vented into compressor frame/crankcase 120 into an intake system of a natural gas engine 18 operating the compressor. See FIGS. 6 and 7. Generally, the evacuator system 50 utilizes vacuum from an air intake system of the natural gas engine contained on compressor packages to draw the gaseous from the interior of the compressor crankcase.

All spark-ignited reciprocating engines such as natural gas engine 18 have an inherent low-pressure zone in the air intake system 52 of the engine. The intake system 52 of the engine 18 is where air and fuel are introduced to the engine 18 and ultimately fed into engine cylinders for combustion. The intake system 52 also typically includes an intake air filter 54. The low-pressure zone (oftentimes referred to as engine vacuum) allows this intake system 52 to serve as an evacuation system for gases within the compressor crankcase. That is, engine vacuum applied through a conduit 62 (e.g., vacuum conduit) fluidly connecting the intake 52 to the interior of the compressor crankcase 120 (e.g., to a breather vent of the crankcase) allows the engine 18 to draw in or evacuate the gases from within the interior of the compressor crankcase 120. Feeding these emissions into the engine combustion cylinders of the engine 18 allow for the oxidation of these emissions/volatile organic compounds (VOCs), turning them into inert gases which have a much lower greenhouse gas affect than the VOCs themselves. In addition, the vacuum applied to the interior of the crankcase 120 may further be transmitted through the drain conduits 156 that collect oil and gases from the packing rods. This vacuum may allow removing gases from within the distance piece in addition to the gases passing out of the drain vent of the packing rod. The overall emission control system, including the oil and gas recovery system that reroutes waste oil and gas blow-by into the crankcase 120 and the evacuator system 50, takes oil and gases that are normally liabilities for a compressor operator and converts them to assets. The emission control system does this by redirecting the gas and oil into the compressor crankcase where the oil is recycled as lubrication for both the compressor frame and the compression cylinders. Further, the gas is collected by the evacuation system from within the compressor crankcase is introduced into the natural gas fired engine for fuel.

As further illustrated in FIGS. 6 and 7, additional components that vent gases to the atmosphere (emission sources) may be connected by various conduits, piping, tubing and/or manifolds to the air intake system 52. In this regard, a discharge port or discharge vent of each of emission source/component (e.g., engine crankcase 19, compressor scrubbers 28, pneumatic valve (s) 44, pneumatic actuator(s) 24 etc.) may be fluidly engaged with a fluid conduit (e.g., collecting conduit 60) that fluidly connects a discharge port/exhaust port of each of these emission sources to interior of the compressor crankcase 120 and/or the conduit 62 connecting the intake system with the interior of the crankcase 120. Vacuum from the air intake system 52 may then continuously draw on each of these emission sources/components and thereby draw gases from each of these components as gas is vented. Accordingly, such vented gases are captured and fed to the engine combustion chambers where they are rendered inert.

While simple in theory, implementing such an evacuator system 50 provides a number of challenges. Such challenges include flow variation, condensation of vented gases and/or controlling exhaust emissions. While the air intake system 52 may provide a near constant level of vacuum to fluidly attached emission sources (e.g., when the engine 18 is operating at steady state), the output flow from the various emission sources fluctuates. For instance, while the compressor crankcase 120 may have a relatively steady rate of venting (e.g., due to blow-by in compression cylinders), emission sources such as the scrubbers 28 operate intermittently. Likewise, the pneumatic valve(s) 44 and pneumatic actuator 24 (e.g., which controls louvers, in an embodiment) operate intermittently. Further, some of these emissions sources can produce relatively large instantaneous or short-duration gas flow rates (i.e., during intermittent operation), which if introduced directly into the engine would cause instability in the combustion process. This instability could have the negative side effect of producing engine exhaust emissions that are out of compliance or worse yet, cause the engine power output to be insufficient for the load and stumble or even die. Thus, a means to smooth out the intermittent nature of some of the emissions sources is required.

To counteract the effect of intermittently introducing combustible gases to the air intake system, the evacuation system 50 utilizes a fuel control system to adjust the air/fuel ratio entering the engine combustion cylinders such that exhaust emissions can remain constant and in compliance. Along these lines, an air/fuel ratio controller 90 is disposed between the conventional fuel supply 92 and the air inlet system 52. See FIG. 6. The air/fuel controller 90 is operatively connected to a sensor 94 disposed within the exhaust 23 of the engine 18. The sensor 94 (e.g., exhaust emissions sensor) continuously monitors exhaust emissions levels and the air/fuel controller 90 continuously adjusts an air/fuel ratio to maintain the exhaust emissions levels in compliance as the air/fuel ratio changes. More specifically, as emissions occur from various emission sources on the compressor package and are admitted to the engine intake system 52, the air/fuel ratio tends to decrease (gets richer). The air/fuel controller 90 compensates for the additional fuel (e.g., adjusts the air/fuel ratio) by decreasing the amount of fuel admitted from the conventional fuel supply 90. In doing so, the air/fuel ratio controller 90 is able to maintain the proper air/fuel ratio entering the engine 18 and thus the engine exhaust emissions remain in compliance in spite of varying changing flow rates of methane emissions being emitted and entering the engine intake system. An air/fuel ratio controller that is capable of making rapid changes to the air/fuel ratio is needed. Such air/fuel controllers are known in the industry and known to those skilled in the art. One exemplary embodiment of such an air/fuel controller is the Engine Integrated Control System manufactured by FW Murphy Production Controls of Tulsa OK.

Condensation of the collected gases may also pose a challenge to implementing the system. Along these lines, emissions from the compressor crankcase 120, while in gas phase, may include water and lubricating oil vapors that can condense into liquids upon cooling. This may be especially true in colder climates. Introducing liquids into the engine air intake system 52 is a recipe for engine damage as liquids are incompressible and the very nature of reciprocating engines is a compression process. Thus, liquids must be first removed from the emissions before being introduced into the engine intake system 52.

In order to remove liquids from the emissions prior to introduction into the engine 18, the presented system may incorporate an oil-mist separator 80 between the engine intake system 52 and all emission sources. That is, an oil-mist separator 80 may be installed upstream of the point where any emissions are introduced into the engine air intake system 52. The oil-mist separator 80 separates oil and water mists and/or condensed liquids from the gaseous emissions. One feature important to such an oil separator for reliable operation is a source of heat such that water vapors do not freeze and oil vapors do not congeal inside of it during low ambient temperatures. Some oil separators utilize a stream of engine oil as such a source of heat. One exemplary embodiment of such an oil separator is the Alfa Laval Defender 500 produced by Alfa Laval Tumba AB located a5t DE-147 80 TUMBA, Sweden. The Defender 500 accomplishes high efficiency separation of liquids by way of centrifugal motion. Internal separation discs/baffles rotate at a high speed, powered by a side stream of engine oil, whose pressure causes a turbine wheel to spin. The engine oil is at elevated temperatures and serves to heat the oil mist separator housing, preventing blockages from frozen water vapors and/or congealed oil. Other separators may be utilized.

Referring again to FIG. 6, the system may, but need not, incorporate another feature. More specifically, the system may incorporate a pressure sensor 70 that monitors the pressure within the interior of the compressor crankcase 120. Though illustrated as being directly coupled to the compressor crankcase in FIG. 6, it will be appreciated that the pressure sensor 70 may be incorporated into the conduit 62 extending between the interior of the crankcase 120 and the intake system 52. The pressure sensor allows an operator to monitor the internal pressure of the compressor crankcase 120. In an embodiment, the pressure sensor is monitored by a control panel 26 (e.g., on-skid control panel). The control panel 26 may include logic that allows monitoring over pressure events in the crankcase and changes in the internal pressure of the crankcase that may provide an indication of overall health of the system. In the latter regard, an overpressure event may be compared to an allowable predetermined baseline pressure. If this baseline pressure is exceeded, the physical limitations of the compressor crankcase may be in danger of being exceeded. In such an event, an alarm may be generated, and a technician may be dispatched for diagnosis and repair and/or the compressor may be shut down. In the latter regard, a change in a monitored pressure may be indicative of one or more components of the system becoming worn. For instance, as noted above, as the rod packing, the gas leak rate through the rod packing will increase accordingly, usually from wear on the piston rod and the rod packing rings.

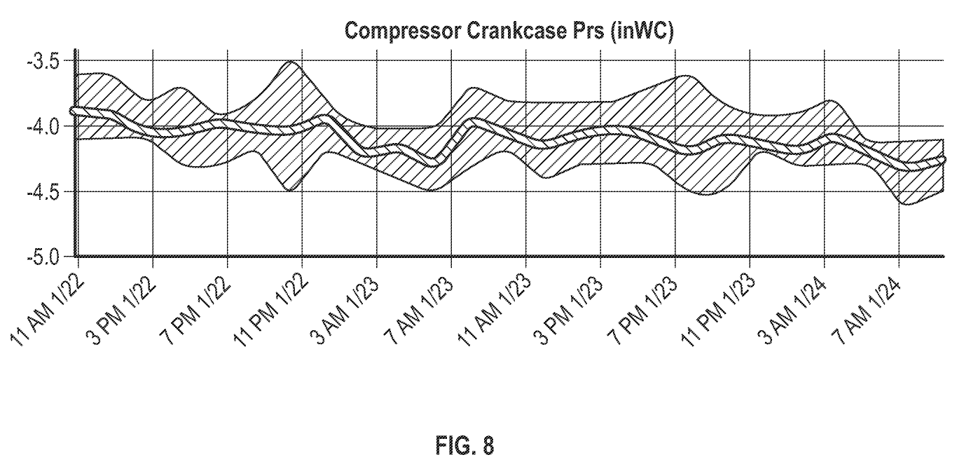

FIG. 8 illustrate an exemplary graph of a monitored compressor crankcase pressure over parts of three days. Generally, the pressure within the interior of the crankcase will be a negative pressure due to the application of vacuum from the air intake of the engine, which is used to evacuate gasses from therein. As shown, the internal pressure fluctuates between in a range shown by upper and lower limits of the shaded region. These fluctuations may be averaged or otherwise fit (e.g., linear regression) to for a trend line as shown by the solid line. As shown, during operation over several days, the spread between the upper and lower limits may vary due to varying operating parameters of the compressor system. Nonetheless, a baseline range or trendline may eventually be established that may represent the normal operation range of the compressor system. In the exemplary embodiment, the normal operating range is between about -3.5 inWC (inches water column) and about -4.5 inWC. If the operating range deviates from the range or trendline and the internal pressure increases, this may be an indication that one of the system components is leaking increased amounts of gas. For instance, if the pressure increases significantly, this may be an indication that one of the rod packings need replacement or that another system component is malfunctioning. Accordingly, upon a monitored pressure exceeding a predetermined value or range, a warning may be generated by the controller indicating that maintenance or repair is required. As will be appreciated, the use of the crankcase pressure sensor (e.g., transducer) may allow for monitoring multiple components of a system using a single sensor rather than requiring each component of the system to have a separate monitoring system or sensor. For instance, the pressure sensor may monitor four rod packings, two or more scrubbers fluidly connected to the crankcase, pneumatic valves etc.

All directional references (e.g., plus, minus, upper, lower, upward, downward, left, right, leftward, rightward, top, bottom, above, below, vertical, horizontal, clockwise, and counterclockwise) are only used for identification purposes to aid the reader’s understanding of the present disclosure, and do not create limitations, particularly as to the position, orientation, or use of the any aspect of the disclosure. As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, which is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A compressor emissions control system for use with a natural gas compressor, comprising:
an oil and gas recovery system having a first drain conduit extending between a first rod packing of the natural gas compressor and a crankcase of the natural gas compressor, wherein oil and gas exiting the first rod packing drains through the first drain conduit into an interior of the crankcase;
an evacuator system having a vacuum conduit fluidly connecting the interior of the crankcase with a vacuum source, wherein the vacuum source draws gases from the interior of the crankcase.

2. The system of claim 1, wherein the oil and gas recovery system comprises a plurality of drain conduits extending between a plurality of rod packings and the crankcase.

3. The system of claim 1, wherein the oil and gas recovery system further comprises a second conduit extending between a gas vent of a housing of the first rod packing and the crankcase.

4. The system of claim 1, wherein the vacuum conduit of the evacuator system extends between and fluidly couples the crankcase and an air intake system of a natural gas engine coupled to the compressor, wherein vacuum from the air intake system draws gases from the interior of the compressor.

5. The system of claim 4, further comprising:
an air-fuel controller, wherein the air-fuel controller is configured to adjust an air fuel ratio of the natural gas engine in response to gases drawn into the natural gas engine from the crankcase.

6. The system of claim 1, further comprising:
an oil mist separator fluidly disposed within a flow path of the at least one vacuum conduit between the crankcase and the air intake system.

7. The system of claim 1, further comprising:
a plurality of collecting conduits, the plurality of collecting conduits fluidly connecting a plurality of emission sources to the crankcase, wherein vacuum from the vacuum source is applied to the plurality of collecting conduits through the crankcase.

8. The system of claim 1, further comprising:
a pressure sensor configured to monitor a crankcase pressure associated with and interior of the crankcase.

9. The system of claim 8, further comprising:
a controller configured to receive an output from the pressure sensor indicative of the crankcase pressure and compare the output to a baseline pressure.

10. The system of claim 9, wherein the controller is operative to generate an output upon determining that the crankcase pressure exceed the baseline pressure.

11. A natural gas compressor package, comprising:
a natural gas compressor having:
a plurality of compressor assemblies each including a piston rod and a rod packing; and
a plurality of drain conduits, each drain conduit connecting to one rod packing of one of the compressor assemblies and being in fluid communication with a crankcase of the natural gas compressor, wherein fluids passing through the drain conduit drain into an interior of a crankcase of the natural gas compressor;
a natural gas engine coupled to the compressor, wherein the natural gas compressor rotates the natural gas compressor, the natural gas engine having:
an air intake system; and
a vacuum conduit extending between and fluidly coupling the interior of the crankcase of the natural gas compressor with the air intake system, wherein vacuum from the air intake system is applied to the interior of the crankcase of the natural gas compressor.

12. The compressor package of claim 11, wherein the oil and gas recovery system further comprises at least one vent conduit extending between a gas vent of a housing of at least one rod packing and the crankcase.

13. The compressor package of claim 11, further comprising:
an air-fuel controller, wherein the air-fuel controller is configured to adjust an air fuel ratio of the natural gas engine in response to gases drawn into the natural gas engine from the crankcase.

14. The compressor package of claim 11, further comprising:
an oil mist separator fluidly disposed within a flow path of the vacuum conduit between the crankcase and the air intake system.

15. The compressor package of claim 11, further comprising:
a pressure sensor configured to monitor a crankcase pressure associated with and interior of the crankcase.

16. The compressor package of claim 15, further comprising:
a controller configured to receive an output from the pressure sensor indicative of the crankcase pressure and compare the output to a baseline pressure.

17. The compressor package of claim 16, wherein the controller is operative to generate an output upon determining that the crankcase pressure exceed the baseline pressure.

18. A method for controlling emissions from a natural gas compressor, comprising:
draining oil and gas received from each rod packing of the natural gas compressor to an interior of the crankcase of the natural gas compressor;
applying a vacuum to an interior of the crankcase of the natural gas compressor to remove gases from the interior of the crankcase;
burning the gases removed from the interior of the natural gas compressor as fuel in an engine connected to the natural gas compressor.

19. The method of claim 18, further comprising:
monitoring an internal pressure of the interior of the natural gas compressor.

20. The method of claim 19, further comprising:
determining excessive leakage from at least one rod packing of the natural gas compressor based on a change in the monitored internal pressure of the crankcase.
